(19) United States
(12) Patent Application Publication
(10) Pub. No.: US 2011/0178943 A1
(43) Pub. Date: Jul. 21, 2011

(54) Systems and Methods For Anonymity Protection

(75) Inventors: Sara Gatmir Motahari, Berkeley, CA (US); Sotirios Ziavras, Fort Lee, NJ (US)

(73) Assignee: NEW JERSEY INSTITUTE OF TECHNOLOGY, Newark, NJ (US)

(21) Appl. No.: 12/972,045

(22) Filed: Dec. 17, 2010

Related U.S. Application Data
(60) Provisional application No. 61/287,613, filed on Dec. 17, 2009.

(51) Int. Cl. G06Q 99/00

(52) U.S. Cl. 705/325

(57) ABSTRACT

In any situation where an individual's personal attributes are at risk to be revealed or otherwise inferred by a third, there is a chance that such attributes may be linked back to the individual. Examples, of such situations include publishing user profile micro-data or information about social ties, sharing profile information on social networking sites or revealing personal information in computer-mediated communication. Measuring user anonymity is the first step to ensure that a users identity cannot be inferred. The systems and methods of the present disclosure, embrace an information-entropy-based estimation of the user anonymity level which may be used to predict identity inference risk. One important aspect of the present disclosure is complexity reduction with respect to the anonymity calculations.

### CROSS REFERENCE TO RELATED APPLICATIONS

The present application claims the benefit of provisional patent application entitled “SYSTEM AND METHOD FOR ANONIMITY [sic.] PROTECTION IN SOCIAL COMPUTING” which was filed on Dec. 17, 2009 and assigned Ser. No. 61/287,613. The entire contents of the foregoing provisional patent application are incorporated herein by reference.

### FEDERAL GOVERNMENT LICENSE RIGHTS

The work described in the present disclosure was sponsored, at least in part, by the following Federal Grants: NSF IIS DST 0534520 and NSF CNS 0454081. Accordingly, the United States government may hold license and/or have certain rights thereto.

### FIELD OF THE INVENTION

The present disclosure relates to identity protection, and more particularly identity protection in a network environment. The present disclosure has particular utility in the fields of ubiquitous and social computing.

### BACKGROUND OF THE INVENTION

Ubiquitous and social computing raise privacy concerns due to the flow of personal information, such as identity, location, profile information, social relations, etc. (for example, social computing applications connect users to each other and typically support interpersonal communication, e.g. Instant Messaging, social navigation, e.g., Facebook and/or data sharing, e.g., flicker.com). Studies and polls suggest that identity is the most sensitive piece of users' information. Motahari, S., Manikopoulos, C., Hiltz, R. and Jones, Q., Seven privacy worries in ubiquitous social computing, ACM International Conference Proceeding Series, Proceedings of the 3rd symposium on Usable privacy and security (2007), 171-172. Thus, anonymity preservation is paramount to privacy protection, particularly in ubiquitous and social computing environments.

In many situations, sharing of personal information may be necessary. For example, there are various scenarios where organizations need to share or publish their user profile micro-data for legal, business or research purposes. In such scenarios, privacy concerns may be mitigated by removing high risk attributes, such as Name, Social Security Number, etc., and/or adding false attributes. Research has shown, however, that this type of anonymization alone may not be sufficient for identity protection. Lodha, S. and Thomas, D., Probabilistic Anonymity, PinKDD

(International workshop on privacy security and trust in KDD), Knowledge Discovery and Data Mining, (2007). For example, according to one study, approximately 87% of the population of the United States can be uniquely identified by their Gender, Date of Birth, and 5-digit Zip-code. Sweeney, L., Uniqueness of simple demographics in the U.S. population, Technical Report LIDAPWP4, Laboratory for International Data Privacy, Carnegie Mellon University, Pittsburgh,

PA, 2000. Thus, attributes such as gender, date of birth and zip-code could be an identity-leaking set of attributes.

Research on privacy protection has mostly focused on identity inference and anonymization (e.g., through insertion of noise, attribute suppression, attribute randomization and/or attribute generalization) in micro-data and data mining applications, where it is usually assumed that the combinations of attributes that lead to identity inference are known. Users of social computing applications, however, share different information with different potential inferrers. Furthermore, user attributes, such as location and friends, may be dynamic and change. A users' anonymity preferences may also be dynamic and change, e.g., based on a context, such as time or location. It is important to note that the socially contextualized nature of information in social computing applications enables an inferrer to use his/her background knowledge (e.g., outside information) to make inferences. In some cases, these inferences may include an inferrer's “best guess” of an attribute. Current solutions, however, tend to ignore the probabilistic nature of identity inference. Current solutions also generally fail in identifying which attributes are identity-leaking attributes.

Current solutions for privacy protection in ubiquitous and social computing applications are mostly limited to supporting users' privacy setting through direct access control systems. See, e.g., Ackerman, M. and Cranor, L., Privacy Critics: UI Components to Safeguard Users' Privacy, SIGCHI conference on Human Factors in computing systems (CHI 99), (1999). Hong, D., Yuan, M. and Shen, V. Y.; Dynamic Privacy Management: a Plug in Service for the Middleware in Pervasive Computing., ACM 7th international conference on Human computer interaction with mobile devices & services (2005); 1-8. Jendricke, U., Kreutzer, M. and Zugenmaier, A., Pervasive Privacy with Identity Management Workshop on Security in Ubiquitous Computing—Ubicomp, (2002); and Langheinrich, M., A Privacy Awareness System for Ubiquitous Computing Environments in 4th International Conference on Ubiquitous Computing (Ubicomp 2002), (2002), 237-245.

Anonymity has been discussed in the realm of data mining, social networks and computer networks, with several attempts to quantify the degree of user anonymity. For example, Reiter and Rubin define the degree of anonymity as 1-p, where p is the probability assigned to a particular user by a potential attacker. Reiter, M. K. and Rubin, A. D., Crowds: Anonymity for Web Transactions, Communications of the ACM, 42 (2), 32-48 This measure of anonymity, however, does not account for network context, e.g., the number and characteristics of other users in the network.

To measure the degree of anonymity of a user within a dataset, including information for a plurality of users, Sweeny proposed the notion of k-anonymity. Sweeney, L., k-anonymity: a model for protecting privacy, International Journal on Uncertainty, Fuzziness and Knowledge-based Systems, 10 (5), 557-570; and Sweeney, L., Uniqueness of simple demographics in the U.S. population, Technical Report LIDAPWP4, Laboratory for International Data Privacy, Carnegie Mellon University, Pittsburgh, PA (2000). In a k-anonymized dataset, each user record is indistinguishable from at least k-1 other records with respect to a certain set of attributes. This work gained popularity and was later expanded by many researchers. For example, L-diversity was suggested to protect both identity and attribute inferences in databases. Machanavajjhala, A., Gehrke, J. and Kifer, D., f-Diversity: Privacy Beyond k-Anonymity, Proceedings of the 22nd IEEE International Conference on Data Engineering (ICDE) (2006). L-diversity adds the constraint that each group of k-anonymized users has L different values for a predefined set of L sensitive attributes. k-anonymity techniques can be broadly classified into generalization techniques, generalization with tuple suppression techniques, and data swapping and randomization techniques.

Recent efforts have been made to try to address several major problems with k-anonymity:

First, k-anonymity solutions improperly assume that the a user can identify which attributes are important for identification purposes. Although a need to model background knowledge has been recognized as an issue in database confidentiality for a number of years, previous research on anonymity protection has failed on this important issue. Thuraisingham, B., Privacy Constraint Processing in a Privacy-Enhanced Database Management System. Data and Knowledge Engineering, 55 (2), 159-188. Thus, identifying such attributes remains an unsolved problem.

Second, a k-anonymized dataset is anonymized based on a fixed pre-determined k which may not be the proper value for all users and all possible situations. For example, Lodha and Thomas tried to approximate the probability that a set of attributes is shared among less than k individuals for an arbitrary k. Lodha, S. and Thomas, D., Probabilistic Anonymity, PinKDD

(International workshop on privacy security and trust in KDD) workshop in Knowledge Discovery and Data Mining, (2007). Lodha and Thomas, however, made unrealistic assumptions in their approach, such as assuming that an attribute takes its different possible values with almost the same probability or assuming that user attributes are not correlated. Although such assumptions may simplify computations, they are seldom valid in practice. Indeed, in practice, different values of an attribute are not necessarily equally likely to occur. Furthermore, users' attributes may often be correlated to one another (e.g., age, gender and even ethnicity correlate with medical conditions, occupation, education, position, income and physical characteristics; home country correlates with religion; religion correlates with interests and activities, etc.). Therefore, the probability of a combination of a number of attributes cannot necessarily be obtained from the independent probabilities of the individual attributes.

Third, k-anonymity incorrectly assumes that k individuals (who share the revealed information) are completely indistinguishable from each other. Thus, all k individuals are equally likely to be the true information owner. This fails to account for, e.g., the nondeterministic background knowledge of the inferrer.

As the next potential solution, machine learning also does not appear to be a reliable option for determining anonymity. See Motahari, S., Ziavras, S. and Jones, Q., Preventing Unwanted Social Inferences with Classification Tree Analysis, IEEE International Conference on Tools with Artificial Intelligence (IEEE ICTAI), (2009). Machine learning shares many of the same problems as k-anonymity. This is further complicated by the fact that user attributes are normally categorical variables that may be revealed in chunks. Thus, to estimate the degree of anonymity, machine learning would need to be able to capture joint probabilities of all possible values for all possible combinations of attributes (mostly categorical) and detect outliers, which may not have appeared in the training set.

While privacy in data mining has been an important topic for many years, privacy for social network (social ties) data is a relatively new area of interest. A few researchers have suggested graph-based metrics to measure the degree of anonymity. Singh, L. and Zhan, J., Measuring topological anonymity in social networks, Proceedings of the 2007 IEEE

International Conference on Granular Computing (2007), 770. Other researchers have suggested algorithms to test a social network, e.g., by de-anonymizing it. Narayanan, A. and Shmatikov, V., De-anonymizing Social Networks. IEEE symposium on Security and Privacy (2009). Very little has been written on preserving anonymity within social network data. See Campan, A. and Truta, T. M., Data and Structural k-Anonymity in Social Networks, Lecture Notes in Computer Science (Privacy, Security, and Trust in KDD), Springer Berlin/Heidelberg, 2009, 33-54.

Information entropy has been applied in the context of connection anonymity; Serjantov and Danezis, Diaz et al., and Toth et al. suggested information theoretic measures to estimate the degree of anonymity of a message transmitter node in a network that uses mixing and delaying in the routing of messages. Serjantov, A. and Danezis, G., Towards an Information Theoretic Metric for Anonymity, Proceedings of Privacy Enhancing Technologies Workshop (PET 2002), (2002); Diaz, C., Seys, S., Claessens, J. and Preneel, B., Towards measuring anonymity, Proceedings of Privacy Enhancing Technologies Workshop (PET),(2002); and Toth, G., Hornak, Z. and Vajda, F., Measuring Anonymity Revisited, Proceedings of the Ninth Nordic Workshop on Secure IT Systems, 85-90 (2004). While Serjantov and Danezis and Diaz try to measure the average anonymity of the nodes in the network, the work in T6th measures the worst case anonymity in a local network. Unlike the earlier approaches, their approach does not ignore the issue of the attacker's background knowledge, but they make abstract and limited assumptions about it that may not result in a realistic estimation of the probability distributions for nodes.

More importantly, their approach measures the degree of anonymity for fixed nodes (such as desktops) and not users. Denning and Morgenstern suggested a possibility of using information entropy to predict the risk of such probabilistic inferences in multilevel databases. Denning, D. E. and Morgenstern, M, Military database technology study: AI techniques for security and reliability SRI Technical report (1986); Morgenstern, M, Controlling Logical

Inference in Multilevel Database Systems. in IEEE symposium on security and privacy, (1988), 245-255; and Morgenstern, M, Security and Inference in Multilevel Database and Knowledge-Based Systems, International Conference on Management of Data archive, Proceedings of the 1987 ACM SIGMOD international conference on Management of data (1987), 357-373. They did not show or disclose how to calculate such risk, nor did they disclose calculating a conditional entropy for the user.

Despite efforts to date, a need exists for improved systems and methods for protecting anonymity during computer-mediated communication. These and other needs are satisfied by the systems and methods of the present disclosure.

### SUMMARY OF THE INVENTION

Systems and methods for protecting anonymity over a network are disclosed herein. In exemplary embodiments, a method, according to the present disclosure, may include steps of (i) ascertaining a set of one or more linkable attributes for a user, and (ii) determining a level of anonymity for the user by calculating a conditional entropy for user identity, given the set of linkable attributes. Depending on the determined level of anonymity, a responsive action may be initiated for protecting the user's identity.

In some embodiments, the set of linkable attributes may include a probabilistic attribute, e.g., characterized by the probability distribution for all possible values of the attribute. In other embodiments, the set of linkable attributes may include an attribute revealed by the user during communication over the network. In exemplary embodiments, the set of linkable attributes may include an attribute which is inferable from one or more communications, e.g., based on an estimated background knowledge for an intended recipient or group of recipients.

In some embodiments, the level of anonymity may be compared to an anonymity threshold calculated based on a desired degree of obscurity. Thus, e.g., the set of linkable attributes may be identified as an identity-leaking set if the level of anonymity is less than the anonymity threshold. In exemplary embodiments, a responsive action may be initiated if the level of anonymity is less than the anonymity threshold.

In some embodiments, the set of linkable variables accounts for an estimated background knowledge of users over a network. In exemplary embodiments, it may be assumed that a determined set of attributes would be relevant to users over a network for the purpose of distinguishing a user's identity. In other embodiments; the background knowledge may be estimated based on a network context. For example, school-related attributes may be considered more relevant in a school-related network. In some embodiments, background knowledge may be estimated by collecting and using data, e.g., conducting relevant user studies over the network and/or monitoring one or more users over the network.

In exemplary embodiments, communications between the user and another individual over the network may be monitored, e.g., in order to identify user attributes which are revealed in or inferable from the communications. The identified attributes may be analyzed to determine if revealing the attribute or allowing the attribute to be inferred would pose a risk. In exemplary embodiments, only attributes which, based on an estimated background knowledge for the other individual may be linked by the other individual to the outside world, are analyzed. Non-linkable attributes may advantageously be disregarded without expending computing power for analysis. In some embodiments, the set of linkable attribute and the level of anonymity for the user may be dynamically determined based at least in part on monitoring of the communications.

In some embodiments, the disclosed methods may include steps of determining whether the set of linkable attributes includes an identifying attribute. In the event that an identifying attribute is detected, there is no need to expend computing power, e.g., to determine the level of anonymity, since the set of linkable attributes is already known to be an identity-leaking set. Thus, a responsive action may be immediately initiated.

In exemplary embodiments, the disclosed methods may include steps of determining a degree of obscurity for the user, e.g., based on the number of users over the network which are possible matches for the set of linkable attributes. In some embodiments, the determined degree of obscurity for the user may be compared relative to a sufficiency threshold, e.g., wherein a value greater than the sufficiency threshold implies that identity is secure and avoids having to expend computing power, e.g., determining the level of anonymity. The determined degree of obscurity may also be compared relative to a desired degree of obscurity, e.g., as provided by the user. Thus, an identity risk can be assumed to exist where the determined degree of obscurity is less than the desired degree of obscurity. In such cases, computation of the level of anonymity may be bypassed and an immediate responsive action taken.

Exemplary actions which may be taken, according to the methods described herein, e.g., in response to an identity risk, include, without limitation, blocking, revoking, rejecting, editing or otherwise manipulating a communication containing a linkable attribute, warning the user about an identity risk or potential identity risk, providing a security status for anonymity, taking a proactive action to strengthen anonymity, introducing false information to increase anonymity, etc.

Exemplary systems for protecting anonymity, according to the present disclosure, may generally include a non-transitory computer readable medium storing computer executable instructions for executing the methods described herein, e.g., for ascertaining a set of one or more linkable attributes for a user, and determining a level of anonymity for the user by calculating a conditional entropy for user identity, given the set of linkable attributes. Systems may further include a processor for executing the computer executable instructions stored on the non-transitory computer readable medium.

Additional features, functions and benefits of the disclosed systems and methods will be apparent from the description which follows, particularly when read in conjunction with the appended figures.

### DETAILED DESCRIPTION OF THE INVENTION

To assist those of ordinary skill in the art in making and using the disclosed systems and methods, reference is made to the appended figures, wherein:

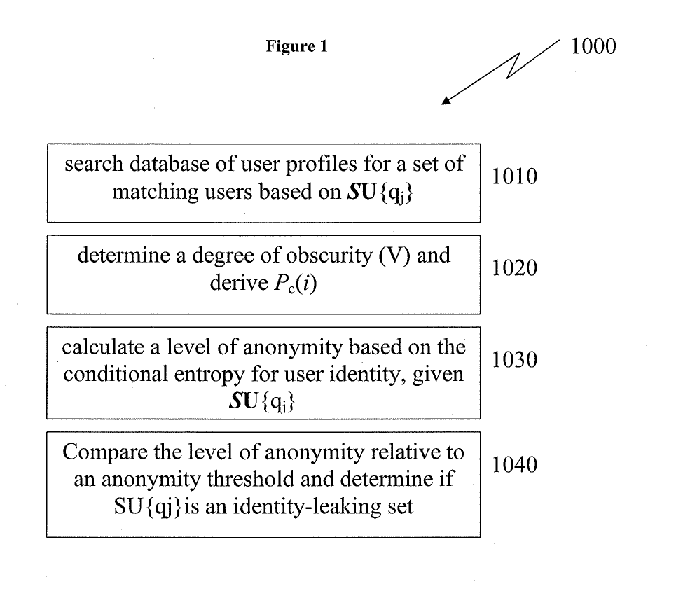

FIG. 1 depicts an exemplary brute force algorithm for determining user anonymity, according to the present disclosure.

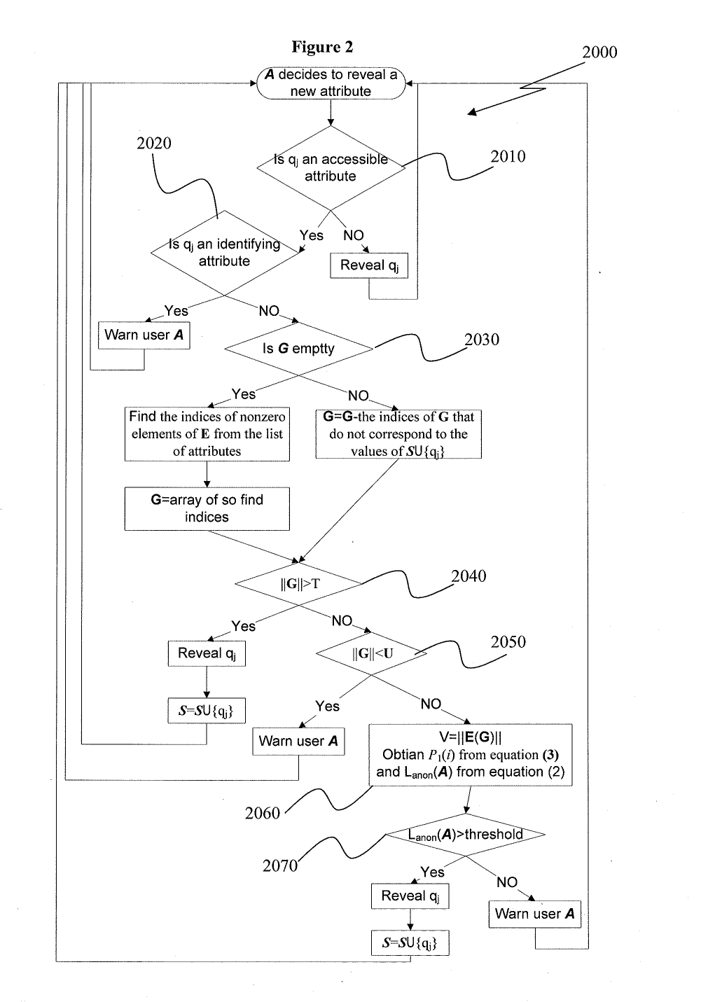

FIG. 2 depicts an exemplary algorithm incorporating complexity reduction techniques for determining user anonymity, according to the present disclosure.

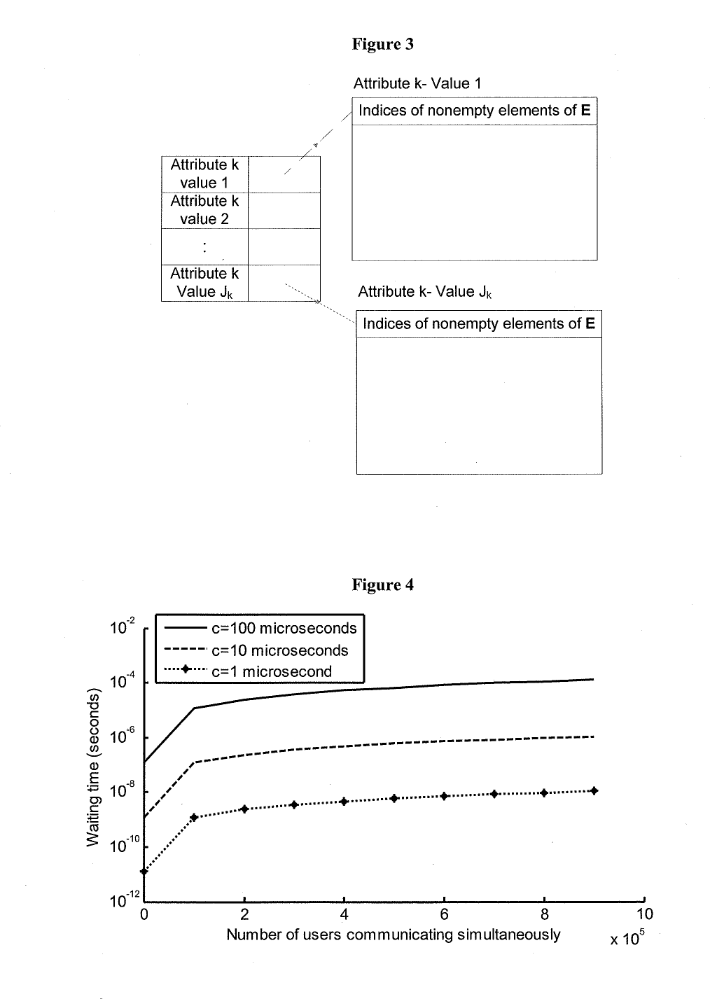

FIG. 3 depicts a data structure for storing a list of values for a given attribute, according to the present disclosure.

FIG. 4 depicts average queuing delay and average communicative duration for a multi-user synchronous computer mediated communication system, according to the present disclosure.

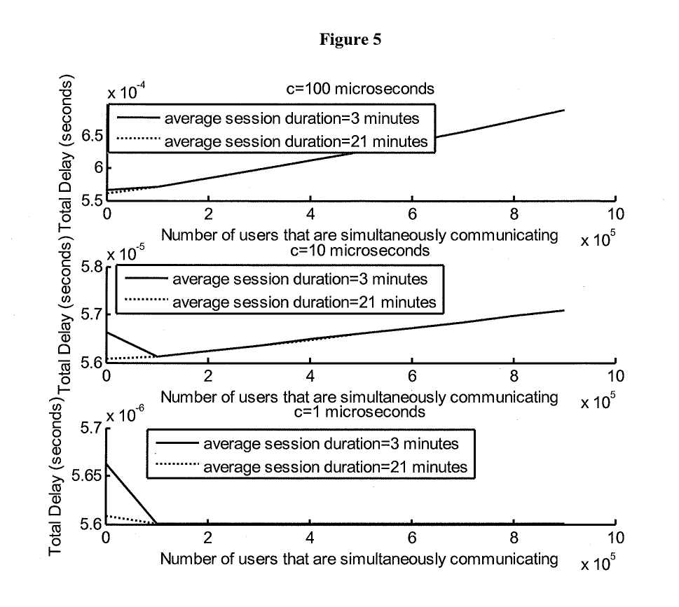

FIG. 5 depicts average of total delay for determining the risk of a revelation in a communication as impacted by the average number of users of the system and session duration.

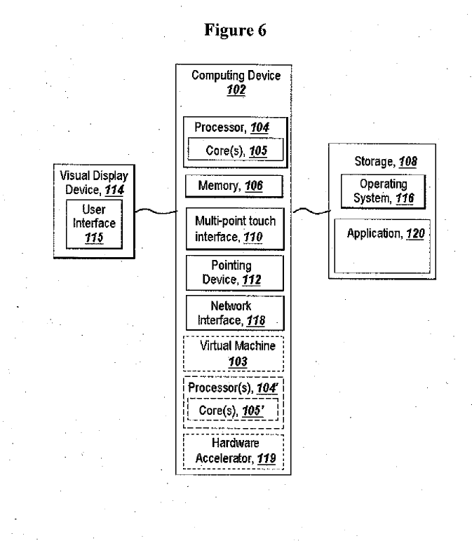

FIG. 6 depicts a block flow diagram of an exemplary computing environment suitable for monitoring and protecting a user's anonymity, as taught herein.

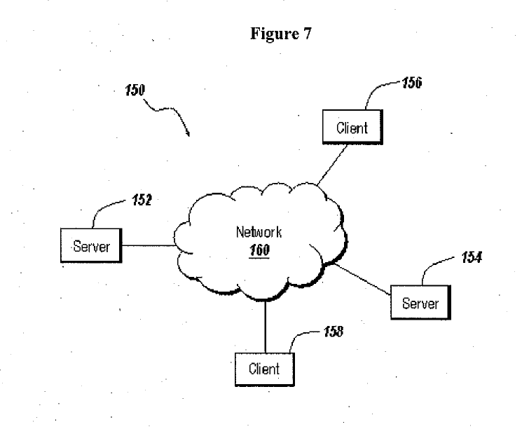

FIG. 7 depicts an exemplary network environment suitable implementations of the embodiments taught herein.

### DETAILED DESCRIPTION OF EXEMPLARY EMBODIMENT(S)

Advantageous systems and methods are presented herein for protecting anonymity over a network, e.g., during computer mediated communication. In general, the systems and methods determine a level of anonymity for a user based on the conditional entropy of user identity, given a set of linkable attributes for the user ascertained from one or more computer mediated communications. The level of anonymity may then be used to initiate a responsive action. In exemplary embodiments, a brute-force algorithm may be used to solve for the conditional entropy. Alternatively, a modified algorithm may be implemented to reduce processing time.

### Definitions:

Unless otherwise defined, all technical and scientific terms used herein have the same meaning as commonly understood by one of ordinary skill in the art to which this invention belongs.

Linkable attributes are attributes that are assumed or determined to be relevant to distinguishing a user's identity, e.g., based on an inferrer's background knowledge. Linkable attributes may include but are not limited to general attributes, probabilistic attributes and identifying attributes, as described herein.

Linkable general attributes are attributes that, if revealed, can be linked to the outside world by an inferrer, e.g., using his/her background knowledge. For example, gender and on-campus jobs are typically linkable general attributes but favorite books or actors are typically not linkable general attributes. This is because an inferrer is more likely to have the background knowledge necessary to correlate gender to the outside world than the background knowledge necessary to correlate a favorite book.

Linkable probabilistic attributes are attributes that even if not revealed could be obtained or guessed with a degree of accuracy and then linked. For example, linkable probabilistic attributes may include attributes, such as gender or ethnicity, which can be correlated with some degree of accuracy, e.g., to a user's chat style, hobbies, favorite foods, religion, etc.

Linkable identifying attributes are attributes that uniquely specify people in most cases regardless of their value and regardless of values of other attributes of the user, such as social security number, driving license number, cell phone number, first and last names, and often street home address.

It is noted that that the above categorization of linkable attributes as linkable general attributes, linkable probabilistic attributes or linkable identifying attributes is not limiting.

Indeed, linkable attributes may fall under any of the above categories or different categories. For example, a recent study of background knowledge, e.g., for a specific community, identified the following types of attributes which may be linked to users' identities or obtained externally: Motahari, S., Ziavras, S., Schuler, R. and Jones, Q., Identity Inference as a Privacy Risk in Computer-Mediated Communication, IEEE Hawaii International Conference on System Sciences (HICSS-42), 2008, 1-10:
Profile information that is visually observable, such as gender, approximate weight, height and age, ethnicity, attended classes, smoker/non-smoker, and on-campus jobs and activities;
Profile information that is accessible through phone and address directories, or the organization's (community's) directories and website, such as phone number, address, email address, advisor/ boss, group membership, courses and on-campus jobs; and
Profile information that could be guessed based on the partner's chat style and be linked to the outside world even without being revealed. The authors included gender with a probability of 10.4% and ethnicity with a probability of 5.2%, if not revealed.

Level of Anonymity: In general, the more uncertain or random an event/outcome, the higher the entropy it possesses. Conversely, if an event is very likely or very unlikely to happen, it will have low entropy. Therefore, entropy is influenced by the probability of possible outcomes. It also depends on the number of possible events, because more possible outcomes make the result more uncertain. In embodiments of the present disclosure, the probability of an event is the probability that a user's identity takes a specific value. As the inferrer collects more information, the number of users that match her/his collected information decreases, resulting in fewer possible values for the identity and lower information entropy.

To illustrate, consider the case of Bob, a university student, who uses chat software and engages in an online communication with Alice, a student from the same university. At the start of communication, Bob does not know anything about his chat partner. He is not told the name of the chat partner or anything else about her, so all potential users are equally likely to be his partner (the user probability is uniformly distributed). Thus, the information entropy has its highest possible value. After Alice starts chatting, her language and chat style may help Bob guess her gender and home country. At this point, users of that gender and nationality are more likely to be his chat partner. Thus, the probability for Bob to guess his chat partner is no longer uniformly distributed over the users and the entropy decreases. After a while, Alice reveals that she is a Hispanic female and also plays for the university's women's soccer team. Bob, who has prior knowledge of this soccer team, knows that it has only one Hispanic member. This allows Bob to then infer Alice's identity. In summary, identity inferences in social applications happen when newly collected information reduces an inferrer's uncertainty about a user's identity to a level that she/he could deduce the user's identity. Collected information includes not only the information provided to users by the system, but also other information available outside of the application database or background knowledge.

In exemplary embodiments, a set of linked attributes for a user A (which may, advantageously, include or account for an inferrer's background knowledge) is denoted by Q. In general, Q may include statistically significant information such as attributes revealed by a user and/or guessed by an inferrer which the inferrer can relate to user identity. If Q is null, a user's identity (Φ) maintains its maximum entropy. The maximum entropy of Φ, Hₘₐₓ, is calculated as follows:

$${H}_{ma x} = - {\sum }_{1}^{N} P \cdot {log}_{2} P \qquad ( 1 )$$

where P=1/N and N is the maximum number of potential users related to the application.

In exemplary embodiments, the level of anonymity Lₐₙₒₙ(A) for a user A is defined as follows:

$${L}_{anon} ( A ) = H ( Φ \vert Q ) = - {\sum }_{i = 1}^{V} {P}_{c} ( i ) \cdot {log}_{2} {P}_{c} ( i ) \qquad ( 2 )$$

where Φ is the user's identity, H(Φ|Q) is the conditional entropy of Φ given Q, V is the number of possible values for Φ given Q, and P_{c}(i) is the estimated probability that the i^{th} possible value of Φ is the identity of the user A. Note that P_{c}(i) may be calculated as the posterior probability of identity value i, given Q.

In one exemplary embodiment of the present invention, we illustrate the entropy model through the example of Bob and Alice discussed above: Alice is engaged in an on-line chat with Bob. In this case, the “true value” for user identity Φ is Alice's identity, e.g., at name or face granularity. At the beginning of the chat, Alice's identity entropy is at its maximum level, i.e., as determined by equation 1.

After a while, Alice's chat style may enable Bob to guess her gender and home country. At this stage, Q comprises a guess on gender and home country, which changes the probability distribution of values as shown below:

$${P}_{c} ( i ) = \{ \begin{matrix}\frac{{α}_{2} \cdot {α}_{1}}{X 3} + \frac{{α}_{2} \cdot ( 1 - {α}_{1} )}{X 1} + \frac{( 1 - {α}_{2} ) \cdot {α}_{1}}{X 2} , & \begin{matrix}for users of the same \\ gender and country\end{matrix} \\ {α}_{2} \cdot ( 1 - {α}_{1} ) / X 1 + ( 1 - {α}_{2} ) \cdot ( 1 - {α}_{1} ) / V , & \begin{matrix}f or users of only \\ the same gender\end{matrix} \\ ( 1 - {α}_{2} ) \cdot {α}_{1} / X 2 + ( 1 - {α}_{2} ) \cdot ( 1 - {α}_{1} ) / V , & \begin{matrix}for users of only the \\ same country\end{matrix} \\ ( 1 - {α}_{2} ) \cdot ( 1 - {α}_{1} ) / V , & \begin{matrix}for the rest of the \\ users\end{matrix}\end{matrix}$$

wherein V is the number of users that satisfy Q (i.e., Q=[gender=probably female based on chat style but uncertain, ethnicity=probably Hispanic based on country but uncertain]; therefore V=maximum number of potential users N), X1 is the number of users of the same gender (females), X2 is the number of users of the same ethnicity (Hispanics), X3 is the number of users of the same gender and ethnicity, α₁ is the probability of correctly guessing Alice's ethnicity based on a guess of Alice's home country, and α₂ is the probability of correctly guessing Alice's gender.

Alice may then reveal that she is Hispanic. Thus, Q may now include the revealed general attribute for ethnicity, e.g., ethnicity=Hispanic. and probabilistic attribute for gender, i.e., the probability of Alice's gender =female is α₂. Thus:

$${P}_{c} ( i ) = {\{}_{{α}_{2}} \{ \begin{matrix}α 2 / X 1 + ( 1 - α 1 ) / V , & \begin{matrix}for users of the same gender that \\ satify Q\end{matrix} \\ ( 1 - α 1 ) / V , & \begin{matrix}for other users that satisfy \\ Q / X 3 + ( 1 - {α}_{2} ) / V ,\end{matrix}\end{matrix}$$

same gender that satisfy Q, i.e., Hispanic females;

(1-α₂)/V, for all other users that satisfy Q, i.e., Hispanic males

where V is the number of users that satisfy Q (i.e., Q=[gender=probably female based on chat style but uncertain, ethnicity=Hispanic]; therefore V=the number of Hispanics X2) and X3 is the number of Hispanic females.

It is noted that an alternative way for solving for P_{c}(i) at this juncture would be to set the probability α₁ of correctly guessing Alice's ethnicity to 1, since Alice's ethnicity was revealed to be Hispanic. Substituting 1 for αᵢ in the previous P_{c}(i) determination:

$${P}_{c} ( i ) = \{ \begin{matrix}\frac{{α}_{2} \cdot {α}_{1}}{X 3} + \frac{{α}_{2} \cdot ( 1 - {α}_{1} )}{X 1} + \frac{( 1 - {α}_{2} ) \cdot {α}_{1}}{X 2} , & \begin{matrix}for users of the same \\ gender and contry\end{matrix} \\ {α}_{2} \cdot ( 1 - {α}_{1} ) / X 1 + ( 1 - {α}_{2} ) \cdot ( 1 - {α}_{1} ) / V , & \begin{matrix}for users of only the \\ same gender\end{matrix} \\ ( 1 - {α}_{1} ) \cdot {α}_{1} / X 2 + ( 1 - {α}_{2} ) \cdot ( 1 - {α}_{1} ) / V , & \begin{matrix}for users of only the \\ same country\end{matrix} \\ ( 1 - {α}_{2} ) \cdot ( 1 - {α}_{1} ) / V , & \begin{matrix}for the rest of the \\ users\end{matrix}\end{matrix}$$

yields: [symbol]
same gender that satisfy Q, i.e., Hispanic females;
P_{c}(i)=0, for users of only the same gender

(1-α₂)/X2, for users of only the same country

0, for the rest of the users

Given that V, at this junction, equals to the number of Hispanics X2, we see that the same result for P_{c}(i) is achieved. Thus, in exemplary embodiments, a linkable attribute may, be represented in Q, as a probabilistic attribute, e.g., with a probability of 1 or 0. Probability for a null or unknown valued linkable attribute may be uniformly distributed across all possible values. Alternatively, it may be desirable in some embodiments to include a predetermined bias for the probability distribution.

Returning to the example of Bob and Alice, when Alice reveals she is a female too, the probability is uniformly distributed over all Hispanic females. Thus:

P_{c}(i)=1/V, for all users that satisfy Q,

wherein V is the number of users that satisfy Q (i.e., Q=[gender=female, ethnicity=Hispanic]; therefore V=the number of Hispanic females X3).

Finally, when Alice reveals her team membership, V is the number of users that satisfy Q (i.e., [gender=female, ethnicity=Hispanic, and group membership=soccer team]; therefore V=1). At this point, P_{c}(i)=1, for Alice who is the only user that satisfies Q, and entropy is at its minimum level.

Matching Set of Users: A matching set of users based on a set of attributes Q is a set of users who share the same values Q at a moment in time. Let's consider the above example. At the very beginning, Alice's matching users based on her revealed attributes include all users, and at the end, her matching users are female Hispanic soccer players. Therefore, the number of A's matching users based on revealed attributes is V-1, i.e. in order to exclude A.

Degree of Obscurity: In exemplary embodiments, assume that in general, the inferrer's probabilistic attributes include k attributes qₗ, . . . , qₖ that have not been revealed yet and can be known with probabilities αₗ, . . . , αₖ, respectively. If the profile of user i matches the attributes q₁, . . . , qₗ then P_{c}(i) is obtained from the following equation.

[symbol]

where Γⱼ is any subset of {q₁ . . . qₗ} including null and X(Γⱼ) is the number of matching users only based on Γⱼ.

In the special case that P_{c}(i) equals 1/V for all i, user A is completely indistinguishable from V-1 other users (the assumption made in the notion of k-anonymity). Therefore,

H(Φ|Q)=−Σ(1/V). log ₂(1/V)=log ₂V (4)

In this case, the entropy is only a function of V. Since A is indistinguishable from V-1 users, V is A's “degree of anonymity” as defined with respect to k-anonymity. Thus, to avoid confusion, V is referred to herein as a user's degree of obscurity.

Desired Degree of Obscurity: User A's desired degree of obscurity is U if he/she wishes to be indistinguishable from U-1 other users. A user is at the risk of identity inference if her/his level of anonymity is less than a certain threshold. To take a user's privacy preferences into consideration, the anonymity threshold of the present exemplary embodiment can be obtained by using the desired degree of obscurity and replacing V by U in Equation (2):

Anonymity Threshold is defined as log ₂U.

Identity-Leaking Set is defined as a set of attributes in A's profile that if revealed would bring A's level of anonymity down to a value less than A's anonymity threshold.

Background Knowledge Modeling:

A reliable estimation of a level of anonymity and detecting identity-leaking attributes depends on effectively modeling the background knowledge. Thus, in exemplary embodiments,

The first step to finding a set of identity-leaking attributes is to estimate an inferrer's outside information (background knowledge). By modeling the background knowledge for an inferred one is able to identify 1) which attributes, if revealed, would reduce the identity entropy for a particular inferrer and 2) which attributes, even if not revealed, can help the inferrer reduce the identity entropy of a user, e.g., based on conditional probabilities for those attributes. In practice, there is no way of we have no way of controlling what data is learned outside of a database. Thus, even the best model can give only an approximate idea of how safe a database is from inferences.

A number of exemplary techniques for estimating background knowledge are provided herein (see also Motahari, S., Ziavras, S., Schuler, R. and Jones, Q., Identity Inference as a Privacy Risk in Computer-Mediated Communication, IEEE Hawaii International Conference on System Sciences (HICSS-42), 2008, 1-10):

The first and simplest exemplary method is to assume that the inferrer can link any element in an application database to the outside world. The weakness for this method is that usually at least some of the attributes in the database are not known to the inferrer while some parts of the inferrer's background knowledge may not exist in the database.

The second exemplary method is to hypothesize about the inferrer's likely background knowledge taking the context of the application into consideration. Thus, for example, a student's class schedule may have greater within the context of a school network, e.g., where another student in the same school would be the inferrer.

The third exemplary method is to utilize the results of relevant user studies designed to capture the users' background knowledge. The advantage of this method is a reliable modeling of background knowledge.

A further exemplary method may be an extension of the latter two methods with application usage data that allows for continuous monitoring of an inferrer's knowledge, for example, based on a monitoring of computer mediated communications from the inferrer.

Interestingly preliminary results suggest that the second exemplary method is almost as accurate as the third exemplary method in the realm of computer mediated communications and proximity-based applications. Motahari, S., Ziavras, S. and Jones, Q., Protecting Users from Social Inferences: Exploring the Impact of Historical and Background Information, Submitted to

Springer Links International Journal of Information Security. This indicates that considering the context and community of an application may enable effective modeling of the background knowledge. However this may not the case in all applications and user studies may be needed. Such studies can be merged with initial studies of the application, such as usability studies, so the estimation can be obtained with a low cost.

### Computational Algorithms for Estimating Anonymity:

The framework described above can estimate the level of anonymity in any situation where personal attributes are shared, particularly in social computing. However, the computational complexity of calculating parameters such as V and P_{c}(i) might raise concerns over the practicality of building an identity inference protection system for synchronous communications. Usually when profile exchanges happen during computer mediated communication, particularly, synchronous computer mediated communication, identity leaking sets should be detected so that users can be warned, e.g., before sending a new piece of information. Dynamic user profiles consist of attributes that change. For these profiles, prior anonymity estimations cannot be assumed valid, thus relevant estimations have to be computed dynamically on-demand.

For exemplary embodiments, a brute-force algorithm is proposed for determining a user's level of anonymity. The algorithm and its computational complexity are discussed below:

Consider that user A is engaged in communication with user B and reveals some of his profile items. For simplicity, assumptions are made that user profiles are stored in a database and each user has a unique row with attributes that are his profile items. A Users' anonymity threshold(s) may also calculated based on their desired degree of obscurity and stored in a database.

Let S equal the set of revealed/inferred profile attributes for A. Note, that while there may be circumstances when S is not initially null (e.g., depending on B's background knowledge), we assume that S is initially null for simplicity. The computation process would be the same regardless of the initial value of S. The algorithm may advantageously be a recurring algorithm that cycles for each new profile attribute added to S.

Steps for an exemplary brute force algorithm 1000 are depicted in FIG. 1, and described below:

Step 1010: Every time A decides to reveal a new attribute qⱼ or B is able to infer a new attribute qⱼ, if it is a linkable profile item, search the database of user profiles for the set of matching users based on SU {qⱼ}.

Step 1020: Determine V equal to the number users in the set of matching users plus one (for User A), then derive P_{c}(i) from Equation (3).

Step 1030: Calculate user A's anonymity level by applying Equation (2).

Step 1040: If the level of anonymity is equal to or less than this user's anonymity threshold, S U {qⱼ} is an identity-leaking set. Otherwise, reveal qⱼ and set S=S U {qⱼ}.

The most computationally taxing steps in exemplary algorithm 1000 are searching for the set of matching users and obtain V and P JO (Steps 1010 and 102). In step 1, S={q₁, . . . , qⱼ₋ₗ}, which includes previously revealed or inferred linkable attributes of A along with item new attribute qⱼ. The elements in S are compared relative to a database of users. This results in j comparisons for each known user. Assuming that there are at most n linkable profile attributes (including general, probabilistic, and identifying attributes) and N is the total number of users, in the worst case n*(N-1) comparisons and V<N summations may be needed. Thus, the worst case computational complexity is O(n*N) which grows linearly with both n and N. This complexity may be an issue for a large community of users.

A modified algorithm is proposed herein for mitigating the computational complexity presented by the foregoing brute force algorithm. In particular, the modified algorithm relies on a number of properties of information entropy that can be used to reduce complexity. These properties are discussed below:

(1) Information entropy (i.e., the level of user anonymity) is an increasing function of V (A's degree of obscurity) at each stage. Assuming that Y and Z are two subsets of users, where Y is a subset of Z. If A's anonymity level is higher than A's anonymity threshold among the users in Y, his anonymity level will also be higher than its threshold among the users in Z:

$$( A ∈ Y , Y • Z , {\sum }_{i ∈ Y} {P}_{1} ( i ) > threshold ) = > {\sum }_{i ∈ Z} {P}_{1} ( i ) > threshold ;$$

(2) Although probabilistic attributes in the inferrer's background knowledge can slightly deviate P JO from a uniform distribution, a sufficiently large V still results in a level of anonymity being higher than its threshold. We call this value of V the sufficiency threshold, T. The value of the sufficiency threshold that guarantees a high enough level of anonymity for these V users is determined by the minimum possible value of P_{c}(i) and the maximum desired degree of obscurity. It can be derived from the following equation:

$${log}_{2} ( {U}_{ma x} ) = {\sum }_{i = 1}^{T} \cdot ( \frac{{\prod }_{l = 1}^{k} ( 1 - {α}_{l} )}{T} ) \cdot {log}_{2} ( \frac{{\prod }_{l = 1}^{k} ( 1 - {α}_{l} )}{T } ) .$$

wherein the Sufficiency threshold,

$$T = {\prod }_{l = 1}^{k} ( 1 - {α}_{1} ) * {U}_{ma x} 1 / Π ( 1 - {α}_{1} ) ;$$

(3) The maximum level of anonymity for a given degree of obscurity V is log ₂V. If V is less than the desired degree of obscurity U, even the maximum level of anonymity log ₂V is less than the threshold log ₂U. Therefore, for V<U, the level of anonymity is always below its threshold, regardless of the probability P_{c};
(4) This last characteristic relates to sets. Every time A reveals a new attribute qⱼ, since S is a subset of SU {qⱼ}, the set of matching users based on SU {qⱼ} is a subset of matching users based on S.

Referring now to FIG. 2, An exemplary algorithm 2000 is presented below demonstrating how one or more of the above properties may be used to reduce computational complexity without compromising on user privacy. For convenience, we again assume that that user A engages in on-line communication with B, and A's desired degree of obscurity, anonymity threshold, and sufficiency threshold are pre-calculated and stored.

Exemplary algorithm 2000 works with an m-dimensional array E, where m is the number of general and probabilistic attributes (excluding identifying attributes, which means m<n).

Referring now to FIG. 3, each dimension of the m-dimensional array E represents one attribute and the number of elements in the k^{th} dimension equals the number of possible values of the k^{th} attribute, including null. The value of each element is equal to the number of matching users based on a same set of m attribute values denoted by the indices of this element in array E. For example, for m=3 element E_{4,2, 6} holds the number of users whose first attribute has its fourth possible value, the second attribute has its second possible value, and the third attribute has its sixth possible value. Therefore, the total number of users who match based only on the fourth value of the first attribute is calculated

$${\sum }_{j} {\sum }_{i} {E}_{4 , i , j} .$$

The summation aggregates all values for each unrevealed unknown attribute.

In the exemplary embodiment depicted in FIG. 3, a list of values for a given attribute is shown as a one-dimensional array of size identical to the number of this attribute's possible values; each element returns the indices of E's nonzero elements corresponding to the respective attribute value. For example, for ‘female’ as the value of the ‘gender’ attribute, the list of values' element contains a pointer to a one-dimensional array hosting the indices of all elements in E that fall under female (their other m-1 attributes can take any value) and have a nonzero value. Since no user is represented by more than one element in E, the size of this one-dimensional array is always less than the number of users. If the k^{th} attribute has Jₖ possible values, the k^{th} list of values will need at most log ₂(Jₖ) bits for addressing. Categorical variables with too many different values can be compressed and shown by their first few letters in the list.

As depicted in FIG. 2, the exemplary algorithm 2000 takes the following steps. Note that in the exemplary embodiment depicted in FIG. 2 and described herein, S and G are each assumed to be an empty one-dimensional array at the start of a communication session.

At step 2010, l every time an attribute, qⱼ is to be revealed or inferred (210) , if it is not a linkable attribute, allow qⱼ. to be revealed or inferred; Else

At step 202 If attribute qⱼ is an identifying attribute, then, S U {qⱼ} is an identity-leaking set so a responsive action is taking such as warning user A; Else

At step 2030, If G is empty, find the array of indices of the nonzero elements of E that relate to the value of qⱼ from the corresponding ‘list of values’. Set G equal to this array Else eliminate the indices of G that do not correspond to the values of SU {ⱼ};

At step 2040, If the length of G is larger than the sufficiency threshold, allow qⱼ. to be revealed or inferred and set S=SU {qⱼ}; Else

At step 2050, If the length of G is less than A's desired degree of obscurity, S U {qⱼ} is an identity-leaking set. Initiate a responsive action such as warning the user, and if S is empty set G empty; Else

At step 2060 read the values of all elements of E whose indices are stored in the array G. Let V equal the summation of all so obtained values, then derive P_{c}(i), e.g., from Equation (3) and calculate the user's anonymity level, e.g., by applying Equation (2);

At step 2070, If the level of anonymity is equal to or less than its threshold, SU {qⱼ} is an identity-leaking set. Initiate a responsive action such as warning the user, and if S is empty set G empty; Else allow qⱼ. to be revealed or inferred and set S=SU {qⱼ}.

Steps 2020 and 2050 in algorithm 2000 advantageously take advantage of property (3) to decide that SU {qⱼ} is an identity-leaking set. Step 2030 takes advantage of property (4), which says that the set of new indices (corresponding to SU {qⱼ}) is a subset of old indices (corresponding to S). In step 2040, since the value of each nonzero element of E is equal to or higher than one, the number of users who match qⱼ is equal to or more than the size of this array. According to property (2), this revelation is safe. Finally, P_{c}(i) can be easily calculated in step 2060 as it is known what value of a probabilistic value an element refers to. Another advantage of this algorithm relates to situations where rich or completely filled out profiles are not available for all community members and calculations are done based on the available subset of them. In this case, since the profile owners are a subset of a bigger community, based on property (a) a safe revelation remains safe. Only the false positive rate may increase, which may result in false warnings.

In exemplary embodiments, of the present disclosure it is contemplated that, when A is about to reveal a linkableattribute to B, the first step is to search the list of values array for this attribute to find the value to be revealed. As was described with respect to FIG. 3, the k^{th} list of values has Jₖ entries, where Jₖ is the number of possible values of the k^{at} attribute. To reduce the storage space, we may assume that the values of attributes with too many possible values are compressed based on the values' first few characters. The worst case complexity of this step is O(log (Jₖ)). Since array G for each new revelation is a subset of array G for the previous revelation, this search is only performed for the first revelation. A decision can be immediately made if the size of G is more than the sufficiency threshold T or less than the desired degree of obscurity U. In the worst case, the size of G is less than T, but more than U. In this case, all corresponding nonzero elements of E have to be read through the array G using indirect addressing and added to calculate V. Then, their probabilities have to be added to calculate P_{c}(i). Since the number of these nonzero elements is less than T, the worst case complexity of this step is O(T). In summary, the worst case complexity of processing A's first revelation to B is O(log (Jₖ)) and after that the worst case complexity is O(T). This means that the computational complexity does not necessarily increase with the total number of users and most of the time its order is that of a rather small number T. For a large community of users, this maximum complexity is substantially less than the maximum complexity, e.g., of algorithm 1000 of FIG. 1.

The algorithm 2000 of FIG. 2, however, takes up more memory than algorithm 1000 of FIG. 1. The lists of values for the m attributes have a total of

$${\sum }_{k = 1}^{m} {J}_{k}$$

rows and the size of the m-dimensional array E is

$${\prod }_{k = 1}^{m} {J}_{k} .$$

In a social profile with 10 general and probabilistic linkable profile attributes and with an average of 20 different values for each attribute (after compression) the length of the profile list will be 200 entries. The size of E will be 20¹⁰ Bytes or 10.24 TeraBytes, assuming that each attribute value uses a single byte (some attributes, like name, may actually require up to a few compressed bytes while others, like gender, require only a single bit). However, firstly, only up to T elements of E are read each time, using indirect addressing. Secondly, at most N elements of E have nonzero values, which mean E is a sparse array. Sparse arrays can be compressed to substantially reduce the storage space [15].

In the embodiment described with respect to FIG. 2, if a user changes the value of an attribute, the values of two elements in E have to be updated; the element that corresponds to the old values of his m attributes decreases by one, and the element that corresponds to the new values of his m attributes increases by one. Since the indices of both elements are known, this update is very fast. If the former element changes to zero, it has to be removed from the array of nonzero elements through the list of attributes and if the latter element was previously zero, it has to be added to the list of nonzero elements. These updates are not time-sensitive and can be performed in the background.

### Delay Analysis of Simultaneous Communication for Many Users:

The complexity analysis above assumes the worst case for one user during her/his communication. Efforts were also made to estimate the average delay of making a decision about the safety of revealing an attribute just after a user decides to reveal its value. In this particular exemplary embodiment, we assume a large community of registered application users, many of whom could be communicating at the same time.

Similar to common models for customer service, such as call centers, networks, telecommunications, and server queueing, we assume that users arrive at the system according to a Poisson distribution with mean λ and spend an exponentially distributed chat-time with mean 1/μ in the system. Since the users cannot be blocked or dropped, they form an M/M/∞ queuing system in which the number of users in the system follows the Poisson distribution with the mean Nₛ=λ/μ(1−λ/μ). See Bertsekas, D. and Gallager, R., Data Networks. Prentice Hall, 1987.

As discussed above, the computational complexity of a first revelation is O(log (Jₖ)). This means that the worst case processing time is cₗ* log (Jₖ)+c₂T, where c₁ and c₂ are small constant time measures. c₁ is the maximum time needed to compare one attribute value against another and c₂ is the time needed for reading an element from the array, adding it to another number, and multiplying it by a number. This processing time is less than c*(log (Jₖ)+T), where c=max{c₁,c₂}. In this particular exemplary embodiment, we assume the maximum time of c*(log (Jₖ)+T) for the worst case delay analysis. The probability that x users reveal their first attribute during the same millisecond interval can be approximated with the Poisson distribution of mean λ, for the worst case where, any user who starts a session, reveals at least one linkable attribute right after joining the system.

The worst case computational complexity of all other revelations is O(T). We again assume the worst case where processing the safety of revealing each attribute always takes a processing time of cT, where c=max{c₁,c₂}.

The probability that x revelations have to be processed during the same millisecond interval, p(x), is the probability that at least x users are currently present and communicating in the system and x users among them decide to reveal a linkable attribute. We consider the worst case here too where all profile attributes are linkable and all x users need to be processed simultaneously. If the probability that a user present in the system reveals an attribute during any given time unit interval is ε, the probability p(x) is obtained as follows.

$$\begin{matrix}p ( x ) = {\sum }_{i = x}^{N} ( \begin{matrix}i \\ x\end{matrix} ) {{ɛ}^{x} ( 1 - ɛ )}^{i - x} \frac{{N}_{s}^{i}}{i !} {e}^{- {N}_{s }} \\ = \frac{{e}^{- {N}_{s}} \cdot {( {N}_{s} ɛ )}^{x}}{x !} {\sum }_{i = x}^{N} \frac{{( {N}_{s} ( 1 - ɛ ) )}^{i}}{i !}\end{matrix}$$

≈ (for a large number of users)

$$\frac{{e}^{- {N}_{s}} \cdot {( ɛ {N}_{s} )}^{x} {e}^{{N}_{s} ( 1 - s )}}{X !} = \frac{{( ɛ {N}_{s} )}^{x}}{X !} {e}^{- ɛ {N}_{s}}$$

Therefore, the number of revelations that need to be processed in the same millisecond follows the Poisson distribution with mean εNₛ=ελ/μ(1−λ/μ).

Assuming that the first revelation is made independent of further revelations, the total number of simultaneous revelations that need to be processed follows the Poisson distribution with mean εNₛ+λ. Consequently, assuming one server, the revelations to be processed form an M/G/1 queuing system. See Leon-Garcia, A., Probability and Random Processes for Electrical Engineering, Addison Wesley, 1993.

The average waiting time in such a system is obtained from:

Ave(waiting-time)=(εNₛ+λ)*[Ave(processing-time)²+VAR(processing-time)]/2/[1-(εNₛ+λ) Ave(processing-time)] (5)

On average, λ/(εNₛ+λ) of the revelations are the first revelation and take c*(log (Jₖ)+T) milliseconds, while the rest take cT milliseconds. Therefore, the average and variance of processing time are obtained as follows:

Ave(processing-time)=[λ/(εNₛ+λ)][cT+c*log(Jₖ)]+[εNₛ/(εNₛ+λ)](cT). (6)

VAR(processing-time)=∫_{-∞}^{+∞}τ²([εNₛ/(εNₛ+λ]Δ(τ−cT)+[λ/(εNₛ+λ)]Δ(τ−cT−c*log (Jₖ)))d_{τ}=[λ(cT+c*log (Jₖ))²+(εNₛ(cT)²]/[εNₛ+λ] (7)

The average waiting time is obtained by substituting the average and variance of the processing time from Equations (6) and (7) in Equation (5). The total delay which includes queuing delay and processing time equals:

Ave(total-delay)=Ave(waiting-time)+Ave(processing-time) (8)

In exemplary embodiments, data from a laboratory experiment was used to simulate how delay changes by the number of users in the system Nₛ which is equal to ελ/μ(1−λ/μ) and the average duration of a communication session (1/μ). Based on the experimental data, the maximum desired degree of obscurity was 5 and the probability of guessing gender and ethnicity were respectively 0.104 and 0.052. Hence, the sufficiency threshold was equal to 5.6. The probability of revealing an attribute T in any millisecond was 3.8*10⁻⁷. It was assumed that the average value of Jₖ equaled 20 which fit the exeperimental data and other rich profiles.

FIG. 4 depicts the average queuing delay that users experienced due to the presence of other users versus the average number Nₛ of users in the system who are communicating simultaneously and the average duration of communication session.

FIG. 5 depicts the average of total delay for processing the safety of their intended revelation versus the average number of users in the system and the session duration. The average queueing delay (waiting time) in the figure is shown in seconds and the average duration of the communication session is shown in minutes. The variable c is expressed in microseconds.

In a single network, the variable c is on the order of microseconds if we do not consider the need for remote array accesses. Since λ equals μNₛ/(1+Nₛ), when the number of simultaneous communications (Nₛ) and session duration (μ) are low, first revelations represent a high percentage of the overall revelations. Therefore, the average processing time and, consequently, the average total delay is higher. When Nₛ is sufficiently high, the total delay increases with an increasing Nₛ. However, as seen in the figures, the total delay in all cases is on the order of microseconds for up to a million users. This delay should not be noticeable by human users, which means that revelations involving many users can be processed in a very time-efficient manner.

### Machine Embodiments:

It is contemplated that the methods and systems presented herein may be carried out, e.g., via one or more programmable processing units having associated therewith executable instructions held on one or more non-transitory computer readable medium, RAM, ROM, hard drive, and/or hardware for solving for, deriving and/or applying ranking functions according to the algorithms taught herein. In exemplary embodiments, the hardware, firmware and/or executable code may be provided, e.g., as upgrade module(s) for use in conjunction with existing infrastructure (e.g., existing devices/processing units). Hardware may, e.g., include components and/or logic circuitry for executing the embodiments taught herein as a computing process.

Displays and/or other feedback means may also be included to convey detected/processed data. Thus, in exemplary embodiments, ranking results may be displayed, e.g., on a monitor. The display and/or other feedback means may be stand-alone or may be included as one or more components/modules of the processing unit(s). In exemplary embodiments, the display and/or other feedback means may be used to facilitate warning a user of a risk as determined according to the systems and methods presented herein.

The software code or control hardware which may be used to implement some of the present embodiments is not intended to limit the scope of such embodiments. For example, certain aspects of the embodiments described herein may be implemented in code using any suitable programming language type such as, for example, C or C++ using, for example, conventional or object-oriented programming techniques. Such code is stored or held on any type of suitable non-transitory computer-readable medium or media such as, for example, a magnetic or optical storage medium.

As used herein, a “processor,” “processing unit,” “computer” or “computer system” may be, for example, a wireless or wireline variety of a microcomputer, minicomputer, server, mainframe, laptop, personal data assistant (PDA), wireless e-mail device (e.g., “BlackBerry” trade-designated devices), cellular phone, pager, processor, fax machine, scanner, or any other programmable device configured to transmit and receive data over a network. Computer systems disclosed herein may include memory for storing certain software applications used in obtaining, processing and communicating data. It can be appreciated that such memory may be internal or external to the disclosed embodiments. The memory may also include non-transitory storage medium for storing software, including a hard disk, an optical disk, floppy disk, ROM (read only memory), RAM (random access memory), PROM (programmable ROM), EEPROM (electrically erasable PROM), etc.

Referring now to FIG. 6, an exemplary computing environment suitable for practicing exemplary embodiments is depicted. The environment may include a computing device 102 which includes one or more non-transitory media for storing one or more computer-executable instructions or code for implementing exemplary embodiments. For example, memory 106 included in the computing device 102 may store computer-executable instructions or software, e.g. instructions for implementing and processing an application 120 for applying an algorithm, as taught herein. For example, execution of application 120 by processor 104 may programmatically (i) ascertain from one or more computer mediated communications a set Q of one or more linkable attributes for a user; and (ii) determining a level of anonymity for the user by calculating a conditional entropy H(Φ|Q) for user identity Φ, given the set Q of linkable attributes. In some embodiments, execution of application 120 by processor 104 may result initiate an action, e.g., warning a user if the level of anonymity is too low and/or partially blocking an at risk communication.

The computing device 102 also includes processor 104, and, one or more processor(s) 104′ for executing software stored in the memory 106, and other programs for controlling system hardware. Processor 104 and processor(s) 104′ each can be a single core processor or multiple core (105 and 105′) processor. Virtualization can be employed in computing device 102 so that infrastructure and resources in the computing device can be shared dynamically. Virtualized processors may also be used with application 120 and other software in storage 108. A virtual machine 103 can be provided to handle a process running on multiple processors so that the process appears to be using only one computing resource rather than multiple. Multiple virtual machines can also be used with one processor. Other computing resources, such as field-programmable gate arrays (FPGA), application specific integrated circuit (ASIC), digital signal processor (DSP), Graphics Processing Unit (GPU), and general-purpose processor (GPP), may also be used for executing code and/or software. A hardware accelerator 119, such as implemented in an ASIC, FPGA, or the like, can additionally be used to speed up the general processing rate of the computing device 102.

The memory 106 may comprise a computer system memory or random access memory, such as DRAM, SRAM, EDO RAM, etc. The memory 106 may comprise other types of memory as well, or combinations thereof. A user may interact with the computing device 102 through a visual display device 114, such as a computer monitor, which may display one or more user interfaces 115. The visual display device 114 may also display other aspects or elements of exemplary embodiments, e.g., databases, ranking results, etc. The computing device 102 may include other I/O devices such a keyboard or a multi-point touch interface 110 and a pointing device 112, for example a mouse, for receiving input from a user. The keyboard 110 and the pointing device 112 may be connected to the visual display device 114. The computing device 102 may include other suitable conventional I/O peripherals. The computing device 102 may further comprise a storage device 108, such as a hard-drive, CD-ROM, or other storage medium for storing an operating system 116 and other programs, e.g., application 120 characterized by computer executable instructions solving for monitoring and protecting a user's anonymity over a network.

The computing device 102 may include a network interface 118 to interface to a Local Area Network (LAN), Wide Area Network (WAN) or the Internet through a variety of connections including, but not limited to, standard telephone lines, LAN or WAN links (e.g., 802.11, T1, T3, 56kb, X.25), broadband connections (e.g., ISDN, Frame Relay, ATM), wireless connections, controller area network (CAN), or some combination of any or all of the above. The network interface 118 may comprise a built-in network adapter, network interface card, PCMCIA network card, card bus network adapter, wireless network adapter, USB network adapter, modem or any other device suitable for interfacing the computing device 102 to any type of network capable of communication and performing the operations described herein. Moreover, the computing device 102 may be any computer system such as a workstation, desktop computer, server, laptop, handheld computer or other form of computing or telecommunications device that is capable of communication and that has sufficient processor power and memory capacity to perform the operations described herein.

The computing device 102 can be running any operating system such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. The operating system may be running in native mode or emulated mode.

FIG. 7 illustrates an exemplary network environment 150 suitable for a distributed implementation of exemplary embodiments. The network environment 150 may include one or more servers 152 and 154 coupled to clients 156 and 158 via a communication network 160. In one implementation, the servers 152 and 154 and/or the clients 156 and/or 158 may be implemented via the computing device 102. The network interface 118 of the computing device 102 enables the servers 152 and 154 to communicate with the clients 156 and 158 through the communication network 160. The communication network 160 may include Internet, intranet, LAN (Local Area Network), WAN (Wide Area Network), MAN (Metropolitan Area Network), wireless network (e.g., using IEEE 802.11 or Bluetooth), etc. In addition the network may use middleware, such as CORBA (Common Object Request Broker Architecture) or DCOM (Distributed Component Object Model) to allow a computing device on the network 160 to communicate directly with another computing device that is connected to the network 160.

In the network environment 160, the servers 152 and 154 may provide the clients 156 and 158 with software components or products under a particular condition, such as a license agreement. The software components or products may include one or more components of the application 120. For example, the client 156 may monitor and protect anonymity for one or more users over the server 152 based on the systems and methods described herein.

Although the teachings herein have been described with reference to exemplary embodiments and implementations thereof, the disclosed systems and media are not limited to such exemplary embodiments/implementations. Rather, as will be readily apparent to persons skilled in the art from the description taught herein, the disclosed methods, systems and media are susceptible to modifications, alterations and enhancements without departing from the spirit or scope hereof Accordingly, all such modifications, alterations and enhancements within the scope hereof are encompassed herein.

TABLE I
List of Variables

| Symbol | Variable description |
|---|---|
| Lₐₙₒₙ(A) | Level of anonymity of user A |
| V | Degree of obscurity |
| U | Desired degree of obscurity |
| T | Sufficiency threshold |
| threshold | Anonymity threshold |
| S | Set of already revealed attributes |
| P_{c}(i) | The probability that the i^{th} possible value is thought to be |
| | the true value for this identity |
| αₖ | The probability of guessing the k^{th} linkable probabilistic |
| | attribute correctly |
| N | Population of the community of application users |
| n | Number of general, probabilistic and identifying linkable |
| | attributes |
| m | Number of general and probabilistic linkable attributes |
| Jₖ | Number of possible values of the k^{th} attribute |
| Nₛ | Number of users that are simultaneously communicating |
| | in the system |
| μ | Length of a chat session |
| λ | Arrival rate of the users at the system |
| ε | Probability that a user present in the system reveals an |
| | attribute during any given time unit interval |

We claim:

1. A method for protecting anonymity over a network, the method comprising:
ascertaining a set Q of one or more linkable attributes for a user;
determining a level of anonymity for the user by calculating a conditional entropy H(Φ|Q) for user identity Φ, given the set Q of linkable attributes;
initiating a responsive action based on the estimated level of anonymity.

2. The method of claim 1, wherein the conditional entropy H(Φ|Q) is calculated according to the equation
$$H ( Φ \vert Q ) = - {\sum }_{i = 1}^{V} {P}_{c} ( i ) \cdot {log}_{2} {P}_{c} ( i ) ,$$
wherein V is the number of possible values for user identity Φ and wherein P_{c}(i) is the posterior probability an ith identity value, given Q.

3. The method of claim 1, wherein the set Q includes a probabilistic attribute characterized by a probability distribution of possible values for the attribute.

4. The method of claim 1, wherein the set Q includes an attribute revealed in one or more computer mediated communications by the user.

5. The method of claim 1, wherein the set Q includes an attribute which is inferable from one or more computer mediated communications based on an estimated background knowledge for an intended recipient or group of recipients.

6. The method of claim 1, further comprising comparing the level of anonymity to an anonymity threshold calculated based on a desired degree of obscurity.

7. The method of claim 6, wherein the responsive action is initiated if the level of anonymity is less than the anonymity threshold.

8. The method of claim 6, wherein the set Q is determined to be an identity-leaking set if the level of anonymity is less than the anonymity threshold.

9. The method of claim 1, wherein the set Q accounts for an estimated background knowledge of an inferrer over a network.

10. The method of claim 9, wherein the background knowledge is estimated based on an assumption that a determined set of attributes would be relevant to the inferrer for the purposes of distinguishing a user's identity.

11. The method of claim 9, wherein the background knowledge is estimated based on a network context.

12. The method of claim 9, wherein the background knowledge is estimated using relevant user studies over the network.

13. The method of claim 9, wherein the background knowledge is estimated by dynamically monitoring the inferrer user over the network.

14. The method of claim 1, further comprising monitoring communications between the user and an inferrer to identify user attributes revealed by the user or inferable by the inferrer.

15. The method of claim 14, further comprising determining whether an identified user attribute is a linkable user attribute, wherein a non-linkable user attribute is disregarded.

16. The method of claim 14, wherein the set Q and the level of anonymity for the user are dynamically determined based on the monitoring of the communications.

17. The method of claim 1, further comprising determining whether the set Q includes an identifying attribute, wherein the level of anonymity is determined only where the set Q does not include an identifying attribute and wherein, if an identifying attribute is detected, the responsive action is immediately initiated.

18. The method of claim 1, further comprising determining a degree of obscurity for the user, given the set Q, and comparing the degree of obscurity relative to a sufficiency threshold, wherein the level of anonymity is determined only where the degree of obscurity does not exceed the sufficiency threshold.

19. The method of claim 1, further comprising determining a degree of obscurity for the user, given the set Q, and comparing the degree of obscurity relative to a desired degree of obscurity, wherein the level of anonymity is determined only where the degree of obscurity is greater than the desired degree of obscurity and wherein, if the degree of obscurity is less than the desired degree of obscurity, the responsive action is immediately initiated.

20. The method of claim 1, wherein the responsive action includes at least one of: (i) blocking a communication containing a linkable attribute, (ii) warning the user that his/her anonymity is being compromised, (iii) taking a proactive action strengthen anonymity, and (iv) introducing false information of increase anonymity.

21. A system for protecting anonymity over a network the system, comprising:
a non-transitory computer readable medium storing computer executable instructions for:
ascertaining a set Q of one or more linkable attributes for a user; and
determining a level of anonymity for the user by calculating a conditional entropy H(Φ|Q) for user identity Φ, given the set Q of linkable attributes.

22. The system of claim 21, further comprising a processor for executing the computer executable instructions.
